(19) United States
(12) Patent Application Publication
(10) Pub. No.: US 2022/0060233 A1
(43) Pub. Date: Feb. 24, 2022

(54) Reference Signal Sharing In Mobile Communications

(71) Applicant: MediaTek Inc., Hsinchu City (TW)

(72) Inventors: Lung-Sheng Tsai, Hsinchu City (TW); Jiann-Ching Guey, Hsinchu City (TW); Tzu-Han Chou, San Jose, CA (US)

(21) Appl. No.: 17/391,252

(22) Filed: Aug. 2, 2021

Related U.S. Application Data
(60) Provisional application No. 63/067,359, filed on Aug. 19, 2020.
(60) Provisional application No. 63/193,136, filed on May 26, 2021.

(51) Int. Cl. H04B 7/06; H04L 5/00; H04L 27/26

(52) U.S. Cl. CPC H04B 7/0626; H04L 27/2613; H04L 5/0051

(57) ABSTRACT

Examples pertaining to reference signal sharing in mobile communications are described. An apparatus (e.g., UE) receives a plurality of reference signals comprising a first set of reference signals and a second set of reference signals. The apparatus performs time or frequency tracking based on the plurality of reference signals. Alternatively, the apparatus generates a channel state information (CSI) report associated with the plurality of reference signals and transmits the CSI report to a network.

### CROSS REFERENCE TO RELATED PATENT APPLICATION(S)

The present disclosure is part of a non-provisional application claiming the priority benefit of U.S. Patent Application Nos. 63/067,359 and 63/193,136, filed 19 Aug. 2020 and 26 May 2021, respectively, the contents of which being incorporated by reference in their entirety.

### TECHNICAL FIELD

The present disclosure is generally related to mobile communications and, more particularly, to reference signal sharing in mobile communications.

### BACKGROUND

Unless otherwise indicated herein, approaches described in this section are not prior art to the claims listed below and are not admitted as prior art by inclusion in this section.

In mobile communications based on the 3^{rd} Generation Partnership Project (3GPP) standards, dynamic spectrum sharing (DSS) is a technique that utilizes the same spectrum for the concurrent operation of 4^{th} Generation (4G) Long-Term Evolution (LTE) and 5^{th} Generation (5G) New Radio (NR). With DSS, a coordination entity residing in the network can allocate time-frequency resources to serve both LTE and NR devices in the same spectrum in a manner such that devices in one system are unaware of the existence of, and free from the interference from, the other system. DSS is likely to exist for a long time before legacy 4G phases out as operators gradually transition from 4G to 5G. In practice, LTE and NR systems can share the same radio equipment that includes elements such as radio frequency (RF) circuitry and antennas.

In both LTE and NR, reference signals (RSs) are transmitted by the base station (e.g., eNB or gNB or transmission/reception point (TRP)) through one or more antenna ports. Upon reception of a RS transmitted from the antenna ports, a device, or user equipment (UE), can measure the multiple-input-multiple-output (MIMO) radio channel, compute pertinent channel state information (CSI), and feed back the CSI to the base station so that the base station can adapt its subsequent transmission(s) of data packets to the UE. The reference signal transmitted for the purpose of CSI acquisition is referred to as a CSI reference signal (CSI-RS). Both LTE and NR systems can transmit CSI-RS through up to 32 antenna ports.

However, CSI-RS tends to occupy a significant portion of a limited amount of available radio resources, especially in recent deployment where the number of antenna ports tends to be on the high side of the range (e.g., 16 to 32 ports). Currently, LTE and NR systems configure their CSI-RS independently. As such, the CSI-RS transmitted to LTE devices cannot be used by NR devices, even if the transmissions are through the same set of antenna ports common to both LTE and NR because NR devices are unaware of transmissions of the LTE CSI-RS. Consequently, precious radio resources are not efficiently utilized. Therefore, there is a need for a solution of reference signal sharing in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is propose schemes, concepts, designs, systems, methods and apparatus pertaining to reference signal sharing in mobile communications. It is believed that previous radio resources may be more efficiently utilized under the various schemes proposed herein in which part or all of the CSI-RS transmitted by one system (e.g., LTE) may be shared by the other system (e.g., NR), and vice versa.

In one aspect, a method may involve receiving a plurality of reference signals comprising a first set of reference signals and a second set of reference signals. The method may also involve performing time or frequency tracking based on the plurality of reference signals. The method may alternatively involve generating a CSI report associated with the plurality of reference signals and transmitting the CSI report to a network.

In another aspect, an apparatus may include a transceiver and a processor coupled to the transceiver. The transceiver may be configured to communicate wirelessly. The processor may be configured to perform operations involving: (a) receiving, via the transceiver, a plurality of reference signals comprising a first set of reference signals and a second set of reference signals; and either (b) performing, via the transceiver, time or frequency tracking based on the plurality of reference signals; or (c) generating a CSI report associated with the plurality of reference signals and transmitting the CSI report to a network.

It is noteworthy that, although description provided herein may be in the context of certain radio access technologies, networks and network topologies such as 5G/NR and LTE mobile networking, the proposed concepts, schemes and any variation(s)/derivative(s) thereof may be implemented in, for and by other types of wireless and wired communication technologies, networks and network topologies such as, for example and without limitation, Ethernet, Evolved Packet System (EPS), Universal Terrestrial Radio Access Network (UTRAN), Evolved UTRAN (E-UTRAN), Global System for Mobile communications (GSM), General Packet Radio Service (GPRS)/Enhanced Data rates for Global Evolution (EDGE) Radio Access Network (GERAN), LTE-Advanced, LTE-Advanced Pro, Internet-of-Things (IoT), Industrial loT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a block diagram of an example communication system in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to reference signal sharing in mobile communications. According to the present disclosure, a number of possible solutions may be implemented separately or jointly. That is, although these possible solutions may be described below separately, two or more of these possible solutions may be implemented in one combination or another.

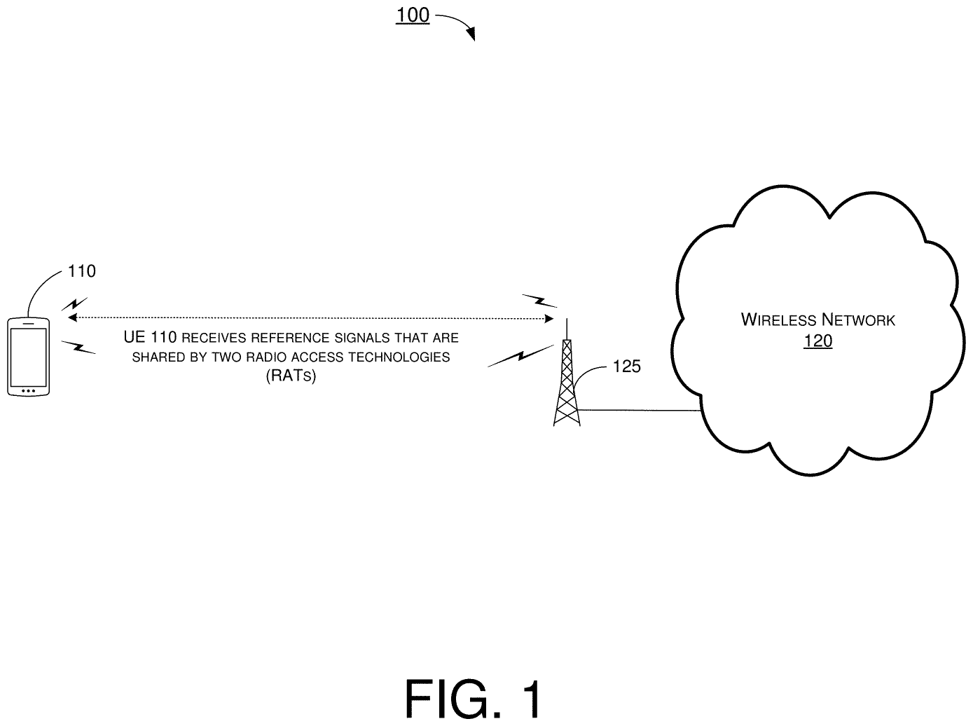

FIG. 1 illustrates an example network environment 100 in which various solutions and schemes in accordance with the present disclosure may be implemented. Referring to FIG. 1, network environment 100 may involve a UE 110 and a wireless network 120. UE 110 and network 120 may be in wireless communications via one or more network nodes (e.g., eNBs, gNBs and/or TRPs) including a network node 125. In network environment 100, UE 110 and wireless network 120 may be configured to implement various schemes pertaining to reference signal sharing in mobile communications in accordance with the present disclosure, as described herein.

Under a first proposed scheme in accordance with the present disclosure, for the purpose of CSI acquisition or time/frequency tracking, network node 125 may transmit reference signals common to both LTE and NR through a common set of antenna ports. Correspondingly, UE 110, equipped to operate in either NR standalone (SA) mode or non-standalone (NSA) mode, may receive the transmitted reference signals common to both LTE and NR, and UE 110 may process the reference signals for CSI feedback or time/frequency tracking based on the reference signals. Moreover, network node 125 may provide to UE 110 operating in NR a configuration on the sharing of the reference signals common to both LTE and NR through one or more methods.

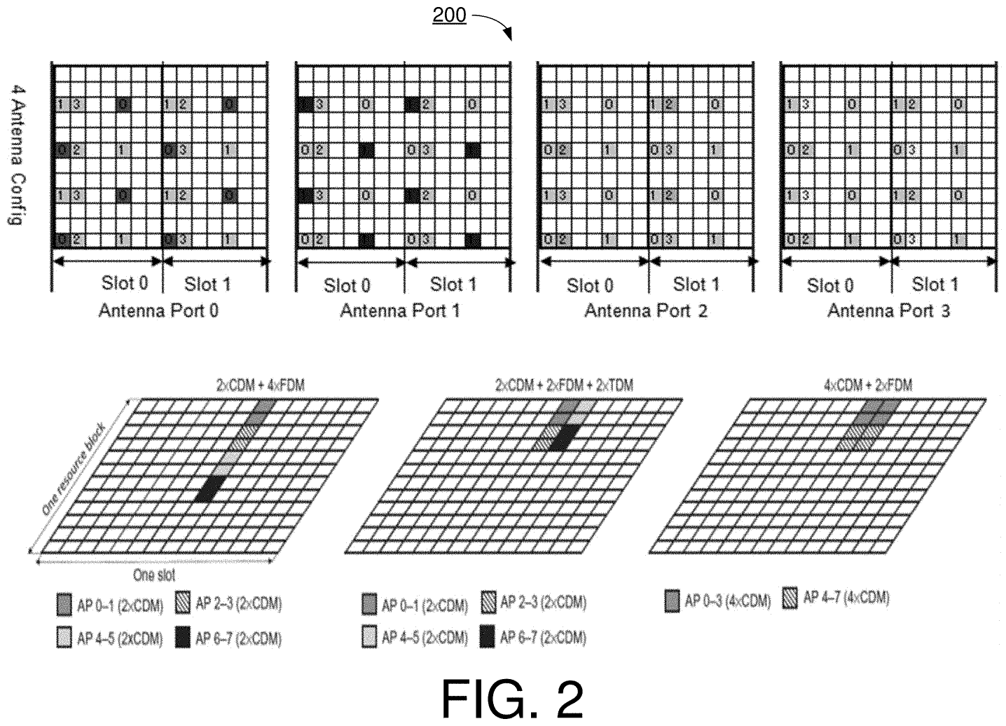

Under the first proposed scheme, a first method may involve introducing a new configuration of NR CSI-RS resource that matches part or all of the configuration of an LTE reference signal. A second method may involve, for a UE (e.g., UE 110) that is connected to both LTE and NR networks, introducing a new signaling that indicates to UE 110 that one or more LTE reference signals are being shared with NR. A third method may involve network node 125 configuring an NR CSI-RS in a manner such that part or all of the NR CSI-RS configuration matches that of part or all of an LTE reference signal. For instance, an NR CSI-RS may be configured to occupy the same time-frequency resource elements (REs) as that of an LTE reference signal, masked by the same code division multiplexing (CDM) orthogonal covering code (OCC) and modulated by the same scrambling sequence as that of the LTE reference signal. Other than the RE locations of the LTE reference signal, additional signaling may be necessary for UE 110 to obtain the value of the LTE reference signal. A fourth method may involve associating a CSI report configuration with measurement resources comprising NR CSI-RS and LTE reference signal together. A fifth method may involve utilizing a new time and/or frequency tracking RS used in NR which may comprise only an LTE reference signal or both the NR CSI-RS and the LTE reference signal. Under the first proposed scheme, the NR CSI-RS resource may include part or all of an LTE reference signal. For instance, a 12-port NR CSI-RS resource may comprise 4 ports from an LTE reference signal and 8 ports from an NR reference signal. The LTE reference signals shared with NR may be LTE CSI-RS or LTE common reference signal (CRS), as shown in FIG. 2.

FIG. 2 illustrates an example scenario 200 under the first proposed scheme. Referring to FIG. 2, in scenario 200, a 12-port CSI-RS may include concatenation of a 4-port LTE CRS and an 8-port NR CSI-RS, thereby forming a composite CSI-RS with less overhead.

Under a second proposed scheme in accordance with the present disclosure, in general, for the functionality of a particular UE (e.g., UE 110) such as CSI estimation or time/frequency tracking based on received reference signals, the first proposed scheme described above may be extended to include defining a set of reference signals including reference signals that are shared between any two radio access technologies (RATs) and/or shared between any two different types of reference signals (e.g., A+B, with A and B being any two of the following: LTE CRS, LTE CSI-RS, LTE synchronization signal block (SSB), LTE demodulation reference signal (DMRS), NR CSI-RS, NR DMRS, NR SSB, and so on). Under the second proposed scheme, a UE (e.g., UE 110) may be configured for a given UE functionality (e.g., CSI reporting) associated with a set of reference signals. The set of reference signals may include: (1) a first set of reference signals associated with and generated by a first reference signal generator, and (2) a second set of reference signals associated with and generated by a second reference signal generator. For instance, UE 110 may be configured to generate a CSI report associated with 12 antenna ports, which may include 4 LTE CRS ports and 8 NR CSI-RS ports. Reference signal generators of LTE CRS and NR CSI-RS may be separately defined in respective 3GPP specifications for LTE and NR.

Under the second proposed scheme, a reference signal generator may define features of a reference signal. Such features may include, for example and without limitation, at least one of the following: a time-frequency location, a sequence (which is typically described by a pseudo-random sequence generator with an initial seed), a modulation (e.g., quadrature phase-shift keying (QPSK), binary phase-shift keying (BPSK), frequency-division modulation (FDM), time-division modulation (TDM), CDM, and mapping rules from the sequence to modulated symbols), and a transmission power. For instance, the CSI-RS generator defined in NR may be specified in Section 7.4.1.5 in 3GPP Technical Specification (TS) 38.211.

In view of the above, each of UE 110 and network node 120 may perform respective operations to implement one or more of the proposed schemes with respect to reference signal sharing in mobile communications. In one aspect, UE 110 may receive a set of reference signals. The set of reference signals may include a first set of reference signals associated with and generated by a first reference signal generator and a second set of reference signals associated with and generated by a second reference signal generator that generate the reference signals. The two reference signal generators may be defined in either the same RAT or two different RATs (e.g., LTE and NR). For instance, the two reference signal generators may be two of the following candidates: (a) a reference signal generator configured to generate CRS sequences in LTE; (b) a reference signal generator configured to generate CSI-RS sequences in LTE; and (c) a reference signal generator configured to generate CSI-RS sequences in NR. UE 110 may derive, generate or otherwise provide a CSI report associated with the set of reference signals. Here, UE 110 may also assume that the set of reference signals is transmitted by the same base station (e.g., network node 125). Alternatively, or additionally, UE 110 may track time and/or frequency assuming the set of reference signals is transmitted by the same base station (e.g., network node 125), based on the set of received reference signals. Here, UE 110 may assume that the set of reference signals is transmitted coherently.

In another aspect, UE 110 may receive a set of reference signals. The set of reference signals may include a first set of reference signals associated with a first set of antenna ports and a second set of reference signals associated with a second set of antenna ports. The first and second sets of reference signals may be separately associated with two different sequence generators that generate the reference signals. Two rules may be defined in either the same RAT or two different RATs (e.g., LTE and NR). The two rules may include two of the following candidate rules: (a) a rule configured to generate CRS sequences in LTE; (b) a rule configured to generate CSI-RS sequences in LTE; and (c) a rule configured to generate CSI-RS sequences in NR. UE 110 may derive, generate or otherwise provide a CSI report associated with both the first set of antenna ports and the second set of antenna ports by assuming the set of reference signals is transmitted by the same base station (e.g., network node 125). Alternatively, or additionally, UE 110 may track time and/or frequency assuming the set of reference signals is transmitted by the same base station (e.g., network node 125), based on the set of received reference signals.

### Illustrative Implementations

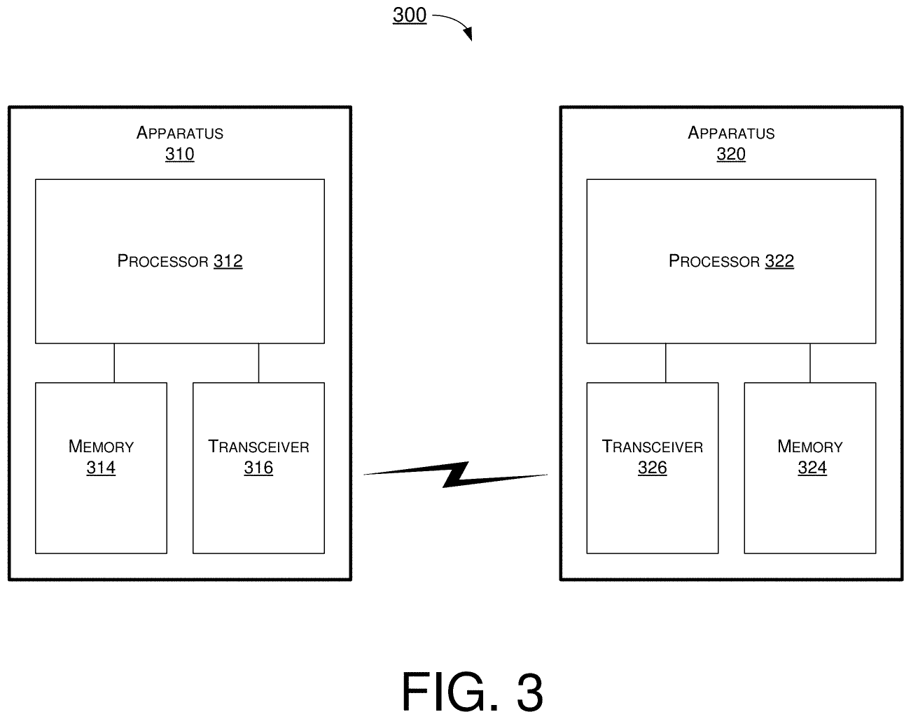

FIG. 3 illustrates an example communication system 300 having at least an example apparatus 310 and an example apparatus 320 in accordance with an implementation of the present disclosure. Each of apparatus 310 and apparatus 320 may perform various functions to implement schemes, techniques, processes and methods described herein pertaining to reference signal sharing in mobile communications, including the various schemes described above with respect to various proposed designs, concepts, schemes, systems and methods described above, including network environment 100, as well as processes described below.

Each of apparatus 310 and apparatus 320 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 310 and apparatus 320 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 310 and apparatus 320 may also be a part of a machine type apparatus, which may be an loT apparatus such as an immobile or a stationary apparatus, a home apparatus, a roadside unit (RSU), a wire communication apparatus or a computing apparatus. For instance, each of apparatus 310 and apparatus 320 may be implemented in a smart thermostat, a smart fridge, a smart door lock, a wireless speaker or a home control center. When implemented in or as a network apparatus, apparatus 310 and/or apparatus 320 may be implemented in an eNodeB in an LTE, LTE-Advanced or LTE-Advanced Pro network or in a gNB or TRP in a 5G network, an NR network or an loT network.

In some implementations, each of apparatus 310 and apparatus 320 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 310 and apparatus 320 may be implemented in or as a network apparatus or a UE. Each of apparatus 310 and apparatus 320 may include at least some of those components shown in FIG. 3 such as a processor 312 and a processor 322, respectively, for example. Each of apparatus 310 and apparatus 320 may further include one or more other components not pertinent to the proposed scheme of the present disclosure (e.g., internal power supply, display device and/or user interface device), and, thus, such component(s) of apparatus 310 and apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC or RISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including those pertaining to reference signal sharing in mobile communications in accordance with various implementations of the present disclosure.

In some implementations, apparatus 310 may also include a transceiver 316 coupled to processor 312. Transceiver 316 may be capable of wirelessly transmitting and receiving data. In some implementations, transceiver 316 may be capable of wirelessly communicating with different types of wireless networks of different radio access technologies (RATs). In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs/wireless networks of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, apparatus 310 may further include a memory 314 coupled to processor 312 and capable of being accessed by processor 312 and storing data therein. In some implementations, apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 314 and memory 324 may include a UICC.

Each of apparatus 310 and apparatus 320 may be a communication entity capable of communicating with each other using various proposed schemes in accordance with the present disclosure. For illustrative purposes and without limitation, a description of capabilities of apparatus 310, as a UE (e.g., UE 110), and apparatus 320, as a network node (e.g., network node 125) of a wireless network (e.g., wireless network 120), is provided below.

Under various proposed schemes in accordance with the present disclosure with respect to reference signal sharing in mobile communications, processor 312 of apparatus 310, implemented in or as UE 110, may receive, via transceiver 316, a plurality of reference signals comprising a first set of reference signals and a second set of reference signals. Additionally, processor 312 may perform, via transceiver 316, time or frequency tracking based on the plurality of reference signals. Alternatively, processor 312 may generate a CSI report associated with the plurality of reference signals and transmit, via transceiver 316, the CSI report to a network (e.g., network 120 via apparatus 320 as network node 125).

In some implementations, the first set of reference signals may be generated by a first reference signal generator, and the second set of reference signals may be generated by a second reference signal generator different than the first reference signal generator. In some implementations, the first reference signal generator and the second reference signal generator may be defined in a same RAT. Alternatively, the first reference signal generator and the second reference signal generator may be defined in different RATs. In such cases, the different RATs may include LTE and NR.

In some implementations, at least one feature of the first set of reference signals and the second set of reference signals may be defined by the first reference signal generator and the second reference signal generator, respectively. In such cases, the at least one feature may include one or more of a time-frequency location, a sequence, a modulation, and a transmission power.

In some implementations, the first reference signal generator and the second reference signal generator may include two of the following: (a) a reference signal generator configured to generate CRS sequences in LTE; (b) a reference signal generator configured to generate CSI-RS sequences in LTE; and (c) a reference signal generator configured to generate CSI-RS sequences in NR.

In some implementations, in generating the CSI report or in performing the time or frequency tracking, processor 312 may assume that the plurality of reference signals are transmitted by a same base station of the network. In some implementations, in performing the time or frequency tracking, processor 312 assume that the plurality of reference signals are transmitted coherently.

In some implementations, in generating the CSI report or in performing the time or frequency tracking, processor 312 may generate the CSI report with an assumption that the plurality of reference signals are transmitted by a same base station of the network.

In some implementations, the first set of reference signals may be associated with a first set of antenna ports, and the second set of reference signals may be associated with a second set of antenna ports.

In some implementations, the first set of antenna ports may be associated with a first reference signal generator, and the second set of antenna ports may be associated with a second reference signal generator different than the first reference signal generator. In some implementations, the first reference signal generator and the second reference signal generator may be defined in a same RAT. Alternatively, the first reference signal generator and the second reference signal generator may be defined in different RATs. In such cases, the different RATs may include LTE and NR. In some implementations, the first reference signal generator and the second reference signal generator may include two of the following: (a) a reference signal generator configured to generate CRS sequences in LTE; (b) a reference signal generator configured to generate CSI-RS sequences in LTE; and (c) a reference signal generator configured to generate CSI-RS sequences in NR.

### Illustrative Processes

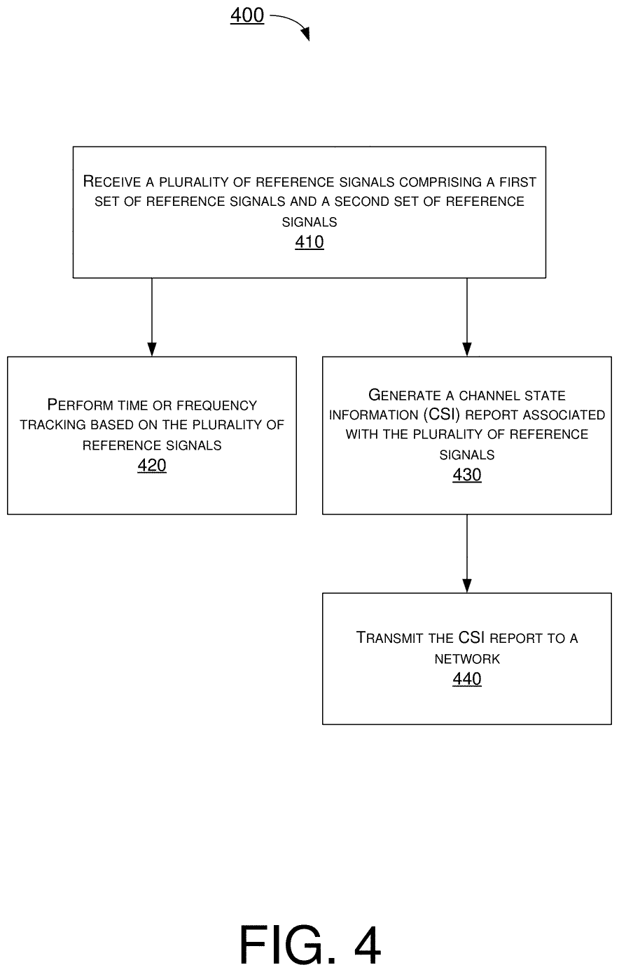

FIG. 4 illustrates an example process 400 in accordance with an implementation of the present disclosure. Process 400 may represent an aspect of implementing various proposed designs, concepts, schemes, systems and methods described above, whether partially or entirely, including those described above. More specifically, process 400 may represent an aspect of the proposed concepts and schemes pertaining to reference signal sharing in mobile communications. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in apparatus 310 and apparatus 320 as well as any variations thereof. Solely for illustrative purposes and without limiting the scope, process 400 is described below in the context of apparatus 310 as a UE (e.g., UE 110) and apparatus 320 as a communication entity such as a network node or base station (e.g., network node 125) of a wireless network (e.g., wireless network 120). Process 400 may begin at block 410.

At 410, process 400 may involve processor 312 of apparatus 310, implemented in or as UE 110, receiving, via transceiver 316, a plurality of reference signals comprising a first set of reference signals and a second set of reference signals. Process 400 may proceed from 410 to 420 or 430.

At 420, process 400 may involve processor 312 performing, via transceiver 316, time or frequency tracking based on the plurality of reference signals.

At 430, process 400 may involve processor 312 generating a CSI report associated with the plurality of reference signals. Process 400 may proceed from 430 to 440.

At 440, process 400 may involve processor 312 transmitting, via transceiver 316, the CSI report to a network (e.g., network 120 via apparatus 320 as network node 125).

In some implementations, the first set of reference signals may be generated by a first reference signal generator, and the second set of reference signals may be generated by a second reference signal generator different than the first reference signal generator. In some implementations, the first reference signal generator and the second reference signal generator may be defined in a same RAT. Alternatively, the first reference signal generator and the second reference signal generator may be defined in different RATs. In such cases, the different RATs may include LTE and NR.

In some implementations, at least one feature of the first set of reference signals and the second set of reference signals may be defined by the first reference signal generator and the second reference signal generator, respectively. In such cases, the at least one feature may include one or more of a time-frequency location, a sequence, a modulation, and a transmission power.

In some implementations, the first reference signal generator and the second reference signal generator may include two of the following: (a) a reference signal generator configured to generate CRS sequences in LTE; (b) a reference signal generator configured to generate CSI-RS sequences in LTE; and (c) a reference signal generator configured to generate CSI-RS sequences in NR.

In some implementations, in performing the time or frequency tracking, process 400 may involve processor 312 assuming that the plurality of reference signals are transmitted by a same base station of the network. In some implementations, in performing the time or frequency tracking, process 400 may involve processor 312 assuming that the plurality of reference signals are transmitted coherently.

In some implementations, in generating the CSI report, process 400 may involve processor 312 generating the CSI report with an assumption that the plurality of reference signals are transmitted by a same base station of the network.

In some implementations, the first set of reference signals may be associated with a first set of antenna ports, and the second set of reference signals may be associated with a second set of antenna ports.

In some implementations, the first set of antenna ports may be associated with a first reference signal generator, and the second set of antenna ports may be associated with a second reference signal generator different than the first reference signal generator. In some implementations, the first reference signal generator and the second reference signal generator may be defined in a same RAT. Alternatively, the first reference signal generator and the second reference signal generator may be defined in different RATs. In such cases, the different RATs may include LTE and NR. In some implementations, the first reference signal generator and the second reference signal generator may include two of the following: (a) a reference signal generator configured to generate CRS sequences in LTE; (b) a reference signal generator configured to generate CSI-RS sequences in LTE; and (c) a reference signal generator configured to generate CSI-RS sequences in NR.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving a plurality of reference signals comprising a first set of reference signals and a second set of reference signals; and
either:
performing a first operation comprising performing time or frequency tracking based on the plurality of reference signals; or performing a second operation comprising:
generating a channel state information (CSI) report associated with the plurality of reference signals; and
transmitting the CSI report to a network.

2. The method of claim 1, wherein the first set of reference signals are generated by a first reference signal generator, and wherein the second set of reference signals are generated by a second reference signal generator different than the first reference signal generator.

3. The method of claim 2, wherein at least one feature of the first set of reference signals and the second set of reference signals is defined by the first reference signal generator and the second reference signal generator, respectively, and wherein the at least one feature comprises one or more of a time-frequency location, a sequence, a modulation, and a transmission power.

4. The method of claim 2, wherein the first reference signal generator and the second reference signal generator are defined in a same radio access technology (RAT).

5. The method of claim 2, wherein the first reference signal generator and the second reference signal generator are defined in different radio access technologies (RATs).

6. The method of claim 5, wherein the different RATs comprise Long-Term Evolution (LTE) and New Radio (NR).

7. The method of claim 2, wherein the first reference signal generator and the second reference signal generator comprise two of:
a reference signal generator configured to generate common reference signal (CRS) sequences in Long-Term Evolution (LTE);
a reference signal generator configured to generate CSI reference signal (CSI-RS) sequences in LTE; and
a reference signal generator configured to generate CSI-RS sequences in New Radio (NR).

8. The method of claim 1, wherein the performing of the first operation or the second operation assumes that the plurality of reference signals are transmitted by a same base station of the network.

9. The method of claim 1, wherein the performing of the first operation or the second operation assumes that the plurality of reference signals are transmitted coherently.

10. The method of claim 1, wherein the first set of reference signals are associated with a first set of antenna ports, and wherein the second set of reference signals are associated with a second set of antenna ports.

11. The method of claim 10, wherein the first set of antenna ports is associated with a first reference signal generator, and wherein the second set of antenna ports is associated with a second reference signal generator different than the first reference signal generator.

12. The method of claim 11, wherein the first reference signal generator and the second reference signal generator are defined in a same radio access technology (RAT).

13. The method of claim 11, wherein the first reference signal generator and the second reference signal generator are defined in different radio access technologies (RATs).

14. The method of claim 13, wherein the different RATs comprise Long-Term Evolution (LTE) and New Radio (NR).

15. The method of claim 11, wherein the first reference signal generator and the second reference signal generator comprise two of:
a reference signal generator configured to generate common reference signal (CRS) sequences in Long-Term Evolution (LTE);
a reference signal generator configured to generate CSI reference signal (CSI-RS) sequences in LTE; and
a reference signal generator configured to generate CSI-RS sequences in New Radio (NR).

16. An apparatus, comprising:
a transceiver configured to communicate wirelessly; and
a processor coupled to the transceiver and configured to perform operations comprising:
receiving, via the transceiver, a plurality of reference signals comprising a first set of reference signals and a second set of reference signals; and
either:
performing a first operation comprising performing, via the transceiver, time or frequency tracking based on the plurality of reference signals; or
performing a second operation comprising:
generating a channel state information (CSI) report associated with the plurality of reference signals; and
transmitting, via the transceiver, the CSI report to a network.

17. The apparatus of claim 16, wherein the first set of reference signals are generated by a first reference signal generator, wherein the second set of reference signals are generated by a second reference signal generator different than the first reference signal generator, wherein at least one feature of the first set of reference signals and the second set of reference signals is defined by the first reference signal generator and the second reference signal generator, respectively, and wherein the at least one feature comprises one or more of a time-frequency location, a sequence, a modulation, and a transmission power.

18. The apparatus of claim 17, wherein the first reference signal generator and the second reference signal generator are defined in different radio access technologies (RATs).

19. The apparatus of claim 17, wherein the first reference signal generator and the second reference signal generator comprise two of:
a reference signal generator configured to generate common reference signal (CRS) sequences in Long-Term Evolution (LTE);
a reference signal generator configured to generate CSI reference signal (CSI-RS) sequences in LTE; and
a reference signal generator configured to generate CSI-RS sequences in New Radio (NR).

20. The apparatus of claim 16, wherein the first set of reference signals are associated with a first set of antenna ports, and wherein the second set of reference signals are associated with a second set of antenna ports.
